(19) United States
(12) Patent Application Publication
(10) Pub. No.: US 2023/0288031 A1
(43) Pub. Date: Sep. 14, 2023

(54) CYLINDER ASSEMBLY FOR A HYDROGEN FUEL CELLS AUTOTRACTION SYSTEM

(71) Applicant: OMB SALERI S.P.A. - SOCIETA' BENEFIT, Brescia (IT)

(72) Inventors: Renato SANTULLI, Brescia (IT); Fatima AMORES, Brescia (IT); Francesco MONDINELLI, Brescia (IT)

(21) Appl. No.: 17/927,238

(22) PCT Filed: May 28, 2021
(86) PCT No.: PCT/IB2021/054689

§ 371 Date: Nov. 22, 2022

(30) Foreign Application Priority Data
May 29, 2020 (IT) 102020000012934

(51) Int. Cl. F17C 13/08; H01M 8/04082; F16K 17/38; F16K 31/00; F17C 13/12

(52) U.S. Cl. CPC F17C 13/084; H01M 8/04201; F16K 17/38; F16K 31/002; F17C 13/123; F17C 2201/0119; F17C 2201/056; F17C 2205/0142; F17C 2205/0146; F17C 2205/0332; F17C 2221/012; F17C 2223/0123; F17C 2223/036; F17C 2260/042; F17C 2270/0168

(57) ABSTRACT

A cylinder assembly for a hydrogen-powered fuel cell motor vehicle system which has a plurality of cylinders and a first thermal safety device is provided. The first thermal safety device has a trigger mechanism and a plurality of trigger wires made of a shape memory material. Each trigger wire of the plurality of trigger wires extends along a straight trigger axis and is connected to the trigger mechanism and to a fixed backing part. The trigger axes are intersecting with each other.

The present invention is in the field of components for hydrogen-powered fuel cell motor vehicle systems. In particular, the present invention relates to a cylinder assembly for storing hydrogen on board the vehicle.

Most hydrogen fuel cell systems for motor vehicle use provide a single cylinder wherein hydrogen is stored at high pressure; a multi-function valve (OTV valve) is applied to a flange of the cylinder for hydrogen refueling and supplying to a fuel cell supply line equipped with numerous accessory devices such as shut-off valves, vent valves, thermal safety devices, etc.

One of the most important requirements in the industry is to ensure a high degree of safety, for example in the event of a fire. In such cases, the system must be capable of rapidly venting all the hydrogen stored in the cylinder in order to avoid an explosion.

For this purpose, known systems are equipped with thermal safety devices, e.g., with a bulb. When the temperature around the bulb exceeds a threshold value, the bulb explodes, and the device goes into an opening configuration that allows the release of hydrogen. Other solutions provide for a thermal safety device with a trigger comprising a wire made of shape memory material, positioned along the cylinder. In this case, the temperature rise in a region crossed by the wire causes the wire to shorten and the thermal safety device to open.

Recently, the need has arisen to use a plurality of smaller cylinders in place of a single larger cylinder in order to expediently exploit some vehicle spaces and allow the same architecture to be shared between electric and fuel cell vehicles, as is already being done with gasoline and diesel vehicles.

This requirement has further complicated the problem of safety in the event of a fire, since the cylinders occupy a very large area and it is necessary to monitor that there are no fires around this area; in other words, it is necessary to monitor the temperature over a large area in order to trigger the safety device in case a threshold temperature value is exceeded.

It is the object of the present invention to provide a cylinder assembly for fuel cell motor vehicle systems that meets the needs of the industry and overcomes the drawbacks discussed above with reference to the prior art.

This object is achieved by a cylinder assembly according to claim 1. The dependent claims identify additional advantageous embodiments of the invention.

The features and advantages of the cylinder assembly according to the present invention will be apparent from the description below, given by way of non-limiting example in accordance with the figures in the attached drawings, wherein:

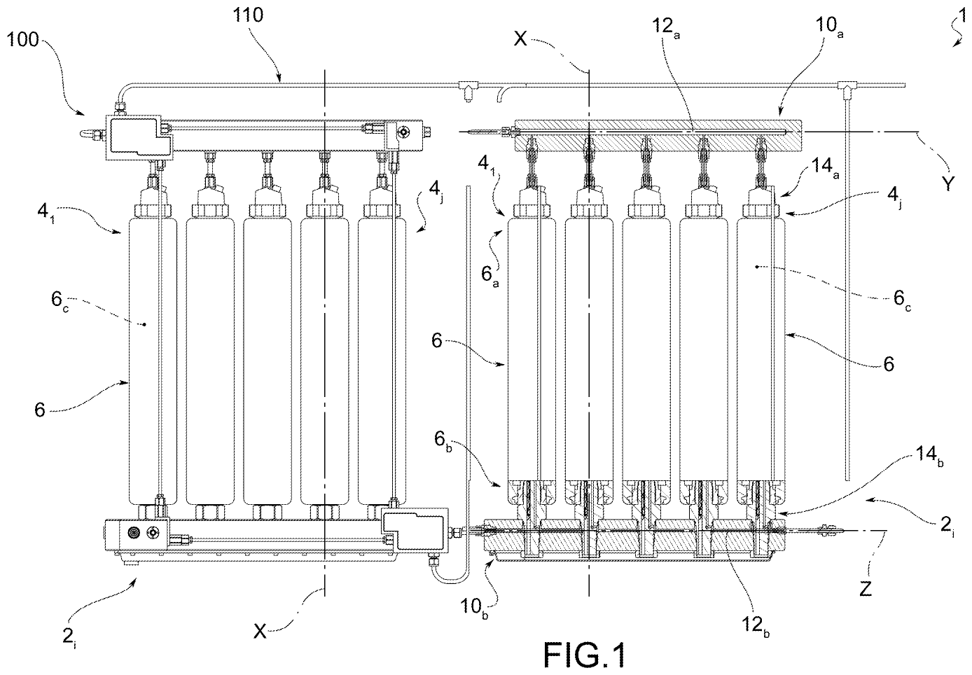

FIG. 1 shows a cylinder assembly according to an embodiment of the present invention;

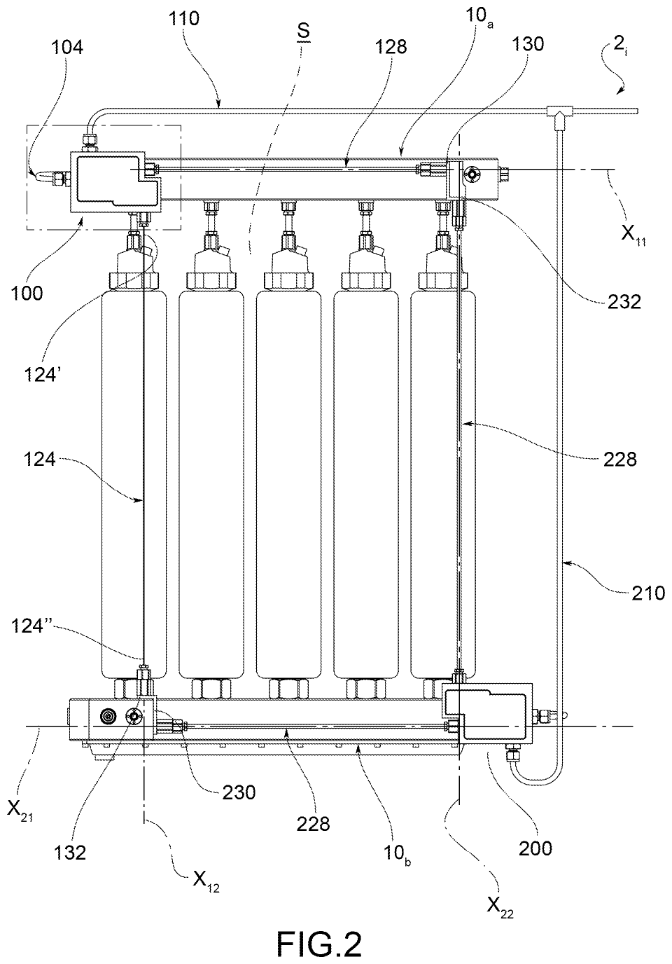

FIG. 2 depicts a module of a cylinder assembly according to an embodiment of the present invention;

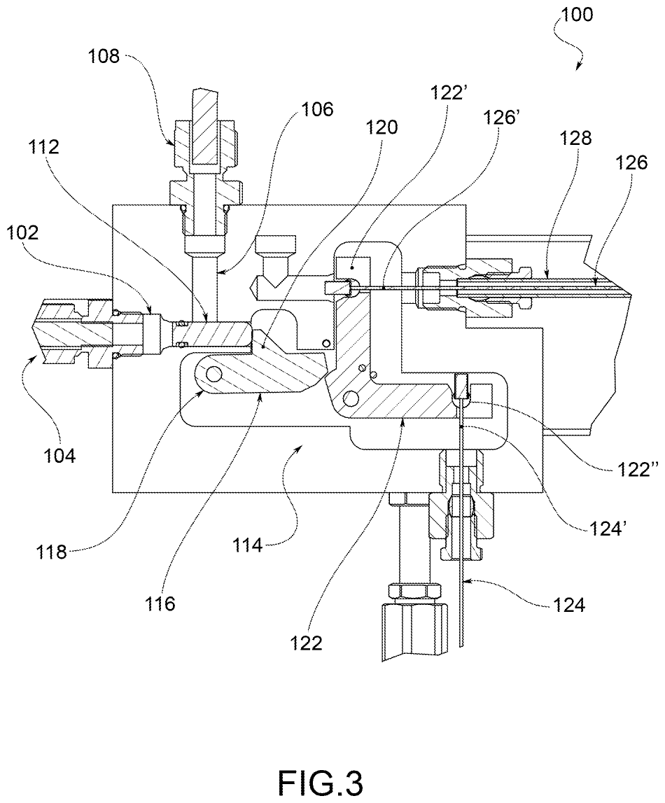

FIG. 3 illustrates a thermal safety device for a cylinder assembly according to an embodiment of the present invention.

With reference to the figures in the attached drawings, a cylinder assembly for a hydrogen-powered fuel cell motor vehicle system according to an embodiment of the present invention has been indicated as a whole with 1.

The cylinder assembly 1 comprises at least one module 2i (with i=1 . . . n, where n is the total number of modules), wherein each module 2i is equipped with a plurality of cylinders 4j (with j=1 . . . m, where m is the total number of cylinders); for example, in the illustrated embodiment, the cylinder assembly 1 comprises modules 21, 22, wherein each module comprises five cylinders 41-45.

According to a variant embodiment, the number of cylinders is the same for each module, as in the illustrated embodiment; according to a further variant embodiment, the number of cylinders of one module is different from the number of cylinders of another module.

Each cylinder 4j comprises a cylinder body 6, typically cylindrical, extending along a central cylinder axis X between a head end 6a and a bottom end 6b and delimits an internal compartment 6c.

Preferably, all the cylinders 4j of a predefined module 2i are ordered and aligned whereby all cylinder axes X are parallel, all head ends 6a face to one side as do, obviously, all bottom ends 6b.

According to the invention, the module 2i comprises a head manifold 10a, arranged on the head end portion 6a, and a bottom manifold 10b, arranged on the bottom end portion 6b.

In such an embodiment, the head manifold 10a comprises a main head conduit 12a, preferably extending along a head axis Y transverse and incident to the cylinder axes X.

Said main head conduit 12a is operatively connected to the internal compartment 6c of each cylinder 4j of the respective module 2i, for example by means of a head assembly 14a applied to the head end 6a of each cylinder 4j.

The cylinder assembly 1 further comprises an inlet device (not shown), for example integrated with the head manifold 10a of the first module 21, suitable for removable connection with a refueling device, for refueling hydrogen to the cylinders. The inlet device is connected to the head conduit of the first module 21.

Moreover, the head conduit 12a of the head manifold 10a of a module 2i is operatively connected to the head conduit of the head manifold of a further module, so as to ensure that all the cylinders in the cylinder assembly are filled via the inlet device.

Further, in such an embodiment, the bottom manifold 10b comprises a bottom conduit 12b, preferably extending along a bottom axis Z transverse and incident to the cylinder axes X.

Said bottom conduit 12b is operatively connected to the internal compartment 6c of each cylinder 4j of the respective module 2i, for example via a bottom assembly 14b applied to the bottom end 6b of each cylinder 4j.

The cylinder assembly 1 further comprises an outlet device (not shown), for example integrated with the bottom manifold 10b of the last module 22, for supplying hydrogen to the user devices. The output device is connected to the bottom conduit of the last module 22.

The bottom conduit 12b of the bottom manifold 10b of a module 2i is also operatively connected to the bottom conduit of the bottom manifold of an additional module, in such a way as to ensure the hydrogen extraction from all the cylinders of the cylinder assembly and the supply downstream via the outlet device.

An example of such an embodiment is illustrated in the Italian patent application No. 10 2020 000 008 224, in the name of the Applicant, whose teaching is incorporated herein.

According to a further embodiment, each module provides only the head manifold, wherein the downstream hydrogen refueling and supply functions are integrated. In such an embodiment, the bottom end of the cylinders is enclosed by a cap of the cylinder body.

An example of such an embodiment is illustrated in the Italian patent application No. 10 2020 000 009 409, in the name of the Applicant, whose teaching is incorporated herein.

According to the invention, the module 2i is provided with a first thermal safety device 100 comprising an inlet conduit 102 operatively connected to the head manifold 10a, preferably to the head conduit 12a, for example via an inlet connection 104, and a discharge conduit 106 operatively connected to a discharge area, for example via a discharge connection 108 connected to a discharge conduit 110.

The first thermal safety device 100 further comprises a shutter 112 operating between the inlet conduit 102 and the discharge conduit 106. In the closing configuration of the first thermal safety device 100, the shutter 112 is in a closed position wherein it prevents the passage of pressurized gas from the inlet conduit 102 to the discharge conduit 106; in the opening configuration, however, the shutter is in an open position wherein it allows the passage of pressurized gas from the inlet conduit 102 to the discharge conduit 106. Preferably, the shutter 112 switches from the closed position to the open position under the action of pressurized gas in the inlet conduit 102.

The first thermal safety device 100 further comprises a trigger mechanism 114 suitable for influencing the shutter 112 and to switch between a locking configuration, wherein it influences the shutter 112 to keep it in the closed position, and an unlocking configuration, wherein the shutter 112 is free to switch to the open position.

According to an embodiment, the trigger mechanism 114 comprises a lockbolt 116 suitable, in the locking configuration, for keeping the shutter 112 in the closed position. Preferably, the lockbolt 116 comprises an element 118 provided with a protruding ridge 120, hinged so as to be rotatable between a locked position, assumed in the locking configuration, wherein the ridge 120 interferes with the shutter 112 and holds it in the closed position, and an unlocked position, wherein it does not interfere with the shutter 112, that is thus free to move into the open position.

The trigger mechanism 114 further comprises a lever 122 suitable for moving from a locked position, assumed in the locking configuration, wherein it holds the lockbolt 116 in the locked position, to an unlocked position, wherein the latch 116 is free to move into the unlocked position, under the influence of the shutter 112 acting on, for example, the ridge 120.

The lever 122 is hinged so as to be rotatable between the locked position and the unlocked position.

The first thermal safety device 100 further comprises a plurality of trigger wires 124, 126, each trigger wire 124, 126 being suitable, independently of the other, for influencing the trigger mechanism 114 to move it from the locking configuration to the unlocking configuration.

In particular, each trigger wire 124, 126 comprises at least one wire comprising a plurality of wire sections, connected in series or parallel, wherein the at least one wire section is made of a shape memory material (SMA) that is suitable for shortening as the temperature rises.

For example, each trigger wire 124, 126 is connected at a first end 124′, 126′ to a respective trigger portion 122′, 122″ of the lever 122, and the pulling action exerted by any of the two trigger wires 124, 126 causes the rotation of the lever 122 in the same direction of rotation to move from the locked position to the unlocked position.

For example, according to the illustrated embodiment, the lever 122 has an L shape, the trigger portions 122′, 122″ comprise end portions of the arms of the lever 122.

Preferably, moreover, the first thermal safety device 100 comprises at least one protective tube 128, wherein a respective trigger wire 126 is housed.

The first thermal safety device 100 further comprises a plurality of fixed backing parts 130, 132 to which a second end 124″, 126″ of the respective trigger wire 124, 126 is attached. A first backing part 130 is attached to the head manifold 10a, whereas a second backing part 132 is fixed to the bottom manifold 10b.

According to one aspect of the invention, the first trigger wire 124 extends along a first trigger axis X11 and the second trigger wire 126 extends along a second trigger axis X12; said trigger axes X11, X12 are straight and converging toward the trigger mechanism 114.

According to the invention, the trigger mechanism 144, preferably the lever 122, is placed at a first end, the first backing part 130 is fixed to the other end of the head manifold 10a, and the second backing part 132 is fixed to a first end of the bottom manifold 10b, whereby the trigger axes X11, X12 are incident to each other, for example orthogonally.

According to a further embodiment, the module 2i is provided with a second thermal safety device 200 that is functionally and structurally identical to the first thermal safety device 100.

The second thermal safety device 200 is connected to the bottom conduit 12b of the bottom manifold 10b; comprises a plurality of trigger wires, each housed in a respective protective tube 228; and further comprises at least one fixed backing part 230, 232, to which a second end of the respective trigger wire is fixed. For example, a first backing part 230 is fixed to the head manifold 10a, and a second backing part 232 is fixed to the bottom manifold 10b.

The first trigger wire of the second thermal safety device 200 extends along a first trigger axis X21, and the second trigger wire extends along a second trigger axis X22; said trigger axes X21, X22 are straight and converging toward the trigger mechanism of the second thermal safety device.

Preferably, the lever of the trigger mechanism of the second thermal safety device 200 is placed at the edge of the bottom manifold 10b, at a first end thereof; the first backing part 230 is fixed to the other end of the bottom manifold 10b; and the second backing part 232 is fixed to a first end of the head manifold 10a, whereby the trigger axes X21, X22 are incident, for example orthogonally.

Consequently, the trigger axes X11, X12, X21, X22 of the first thermal safety device 100 and the second thermal safety device 200 intersect, delimiting a perimeter of an imaginary surface S, wherein the cylinders 4j of the module 2i are located.

According to a variant embodiment (not shown), a thermal safety device comprises three or more trigger wires capable of triggering, independently of each other, the trigger mechanism.

According to a further variant embodiment (not shown), the trigger axes of the trigger wires are straight and converging toward the actuation lever of the respective trigger mechanism and form between them an intersection angle other than a right angle, for example an acute angle or an obtuse angle.

According to a still further variant embodiment (not shown), the trigger axes of all the thermal safety devices of a module are straight and form either an open broken line or a closed broken line, depending on the region to be monitored.

According to a variant embodiment (not shown), the thermal safety device is fixed to a fixed reference separate from the head manifold and/or the bottom manifold.

According to a further variant embodiment (not shown), the backing part of the thermal safety device is fixed to a fixed reference separate from the head manifold and/or bottom manifold.

Innovatively, a cylinder assembly provided with the thermal safety device according to the invention meets the needs of the industry and overcomes the aforementioned drawbacks, as it allows monitoring of even very large regions where cylinders are located, without bending the trigger wire.

In effect, the Applicant has found that a wire made of shape memory material, if bent, for example to define a rectangular perimeter, becomes unusable as a trigger for a thermal safety device, as it assumes non-repetitive, and therefore unreliable, behavior.

It is understood that a person skilled in the art, in order to meet contingent needs, could make modifications to the cylinder assembly described above, all contained within the scope of protection as defined by the following claims.

1-11. (canceled)

12. A cylinder assembly for a hydrogen-fueled fuel cell motor vehicle system, the cylinder assembly comprising at least one module, wherein the at least one module comprises:
a plurality of cylinders, wherein each cylinder of the plurality of cylinders comprises a cylinder body extending along a central cylinder axis between a head end and a bottom end and delimiting an internal compartment; and
a first thermal safety device operatively connected to the internal compartment of each cylinder, the first thermal safety device comprising:
a main body provided with an inlet conduit for pressurized hydrogen, and a discharge conduit toward a discharge area;
a shutter operating between the inlet conduit and the discharge conduit, so that in a closing configuration, the shutter is in a closed position where the shutter prevents passage of pressurized hydrogen from the inlet conduit to the discharge conduit, and in an opening configuration, the shutter is in an open position where the shutter allows passage of pressurized hydrogen from the inlet conduit to the discharge conduit;
a trigger mechanism suitable for influencing the shutter and for passing from a locking configuration, where the trigger mechanism influences the shutter to keep the shutter in the closed position, to an unlocking configuration, where the shutter is free to pass to the open position;
a plurality of trigger wires, wherein
each trigger wire of the plurality of trigger wires comprises at least one wire consisting of a plurality of wire sections, wherein at least one wire section of the plurality of wire sections is made of a shape memory material;
each trigger wire of the plurality of trigger wires extends between a first end and a second end along a straight trigger axis;
each trigger wire of the plurality of trigger wires is connected at the first end to the trigger mechanism and is suitable, irrespective of one another, for influencing the trigger mechanism to bring the trigger mechanism from the locking configuration to the unlocking configuration; and
a plurality of fixed backing parts, each trigger wire being connected at the second end to a backing part of the plurality of backing parts;
wherein the at least one module further comprises a head manifold, arranged on the head end, and a bottom manifold, arranged on the bottom end;
wherein the trigger mechanism is placed at a first end of the head manifold;
wherein a first backing part is fixed to a second end of the head manifold, and wherein a second backing part is fixed to a first end of the bottom manifold, whereby trigger axes are intersecting with each other.

13. The cylinder assembly of claim 12, wherein the trigger mechanism comprises a lever suitable for passing from a locked position taken in the locking configuration, where the lever influences the shutter to keep the shutter in the closed position, to an unlocked position taken in the unlocking configuration, where the lever comprises at least one trigger portion connected to the first end of a respective trigger wire.

14. The cylinder assembly of claim 13, wherein the lever is hinged so as to be rotatable between the locked position and the unlocked position.

15. The cylinder assembly of claim 13, wherein the trigger mechanism comprises a movable lockbolt suitable, in the locking configuration, for keeping the shutter in the closed position, the movable lockbolt being kept in the locking configuration by the lever.

16. The cylinder assembly of claim 15, wherein the lockbolt is rotatable.

17. The cylinder assembly of claim 12, wherein two trigger wires are provided, orthogonal to each other.

18. The cylinder assembly of claim 12, wherein the head manifold comprises a head conduit operatively connected to the internal compartment of each cylinder.

19. The cylinder assembly of claim 12, further comprising a second thermal safety device operatively connected to the internal compartment of each cylinder.

20. The cylinder assembly of claim 19, wherein the bottom manifold comprises a bottom conduit operatively connected to the internal compartment of each cylinder, and wherein the trigger mechanism of the second thermal safety device is applied to the bottom manifold.

21. The cylinder assembly of claim 19, wherein the first thermal safety device and the second thermal safety device are placed so that the trigger axes of the first thermal safety device and the trigger axes of the second thermal safety device intersect, forming a perimeter of an imaginary surface.

22. The cylinder assembly of claim 21, wherein the imaginary surface is a square or a rectangle.
